(19) United States
(12) Patent Application Publication
(10) Pub. No.: US 2026/0273782 A1
(43) Pub. Date: Sep. 17, 2026

(54) FOLDING KNIFE

(71) Applicant: Seiichi NAKAMURA, Seki City (JP)

(72) Inventor: Seiichi NAKAMURA, Seki City (JP)

(21) Appl. No.: 19/162,761

(22) PCT Filed: Mar. 11, 2024
(86) PCT No.: PCT/JP2024/080027

§ 371 Date: Sep. 5, 2025

(30) Foreign Application Priority Data
Mar. 17, 2023 (JP) 2023-043510

(51) Int. Cl. B26B 1/04; B26B 1/06

(52) U.S. Cl. CPC B26B 1/044; B26B 1/06

(57) ABSTRACT

A folding knife includes a blade including a blade portion on a first side end portion and a spine portion on a second side end portion, a grip portion to be gripped by a user, a connection portion connecting a base end portion of the blade to the grip portion in a rotatable manner, a housing section open at a side face portion of the grip portion and being configured to receive the blade portion when the blade is rotated and folded with respect to the grip portion, and a finger hook portion provided in the blade and disposed outside the housing section in a closed state. The finger hook portion is configured to elastically deform when the user applies hooks his/her finger on the finger hook portion to rotate the blade and release the closed state.

### TECHNICAL FIELD

The technology of the present disclosure relates to folding knives.

### BACKGROUND ART

A folding knife can generally be folded by a user rotating a blade toward a grip portion configured to be gripped by the user such that a blade portion of the blade is housed in the grip portion, making it portable. For example, the Patent Document 1 discloses an example of a folding knife.

### PRIOR ART

### Patent Literature

Patent Document 1: JP 2022-145375 A

### SUMMARY

### Technical Problem

In general, it is desirable for a folding knife to be configured so that it can be easily released by a simple one-handed operation by the user from a closed state in which the blade is folded and the blade portion is housed in the grip portion. Therefore, in conventional folding knives, the folded blade is biased by an elastic member provided inside the grip portion and, when the user performs an operation of rotating the blade to open the folding knife, biasing force generated by the elastic member assists rotation of the blade. However, in such a configuration, when the folding knife in a closed state is subjected to an external impact, such as being dropped, the biasing force of the elastic member may cause the blade to rotate and open by itself. Thus, there is still room for improvement in facilitating the operation of opening the folding knife.

It is an objective of the technology of the present disclosure to provide a folding knife that allows the user to perform a simple operation to easily open the folded blade.

### Solution to Problem

The technology of this disclosure can be realized as the following forms:
[Form 1] A form of the technology of the present disclosure is provided as a folding knife. The folding knife of the first form may include: a blade including a blade portion on a first side end portion and a spine portion on a second side end portion; a grip portion to be gripped by a user; a connection portion connecting a base end portion of the blade to the grip portion in a rotatable manner; a housing section open at a side face portion of the grip portion and being configured to receive the blade portion when the blade is rotated and folded with respect to the grip portion; and a finger hook portion provided in the blade and disposed outside the housing section in a closed state, the finger hook portion being configured to, when the user applies an external force by hooking his/her finger on the finger hook portion to rotate the blade and release the closed state, generate an elastic force in a direction repelling the external force.

According to the folding knife of the first form, since the elastic force generated by the finger hook portion acts in the direction assisting rotation of the blade, the operation of opening the folding knife from the closed state can be performed more easily and simply. Further, since the folding knife of the first form has a configuration where elastic force is generated when the user hooks his/her finger on the finger hook portion, in the closed state, there is no risk of elastic force being applied to the blade against the user's intention, thereby preventing a case where the blade is opened to the open state unintentionally.
[Form 2] The folding knife of the first form described above may further include an engagement mechanism configured to hold the closed state until an external force having a predetermined magnitude in a direction separating from the housing section is applied to the blade, the closed state being a state where the blade portion is housed in the housing section and rotation of the blade against the grip portion is restricted by a portion of the blade and a portion of the housing section being engaged, and the elastic force generated by the finger hook portion when the user hooks his/her finger on the finger hook portion to release the closed state may be smaller than the predetermined external force for releasing engagement of the engagement mechanism.

According to the folding knife of the second form, the instant the engagement state of the engagement mechanism is released, the elastic force generated by the finger hook portion up to that point is instantaneously released. Thus, the elastic force can be used as an instantaneous force that powers the rotation of the blade. With this configuration, the operation of opening the folding knife from the closed state can be performed faster and more smoothly, which improves the user's feeling of operation when opening the folding knife. Additionally, with the folding knife of the second form, in the closed state where the blade is folded and the blade portion is housed in the housing section of the grip portion, the engagement mechanism restricts rotation of the blade, thereby preventing the blade from being rotated and the closed state from being released unintentionally.
[Form 3] In the folding knife described in the first or second form described above, the finger hook portion may include an operation portion supported by the blade in a state where fluctuation of posture of the operation portion within a predetermined range is allowed when the finger of the user is hooked, and an elastic member configured to generate an elastic force in a direction repelling the fluctuation when the posture of the operation portion fluctuates.

According to the folding knife of the third form, the finger hook portion can be easily configured by using the operation portion on which the user hooks his/her finger and the elastic member. Further, using the elastic member for the finger hook portion facilitates adjustment of the elastic force generated when releasing the closed state.
[Form 4] In the folding knife described in any of the first, second, and third forms, a portion where the finger of the user is hooked on the finger hook portion may be configured as a projecting portion projecting from a surface of the spine portion in a thickness direction.

According to the folding knife of the fourth form, the finger hook portion can have a configuration that makes it easier for the user to hook his/her finger.
[Form 5] In the folding knife described in any of the first, second, and third forms, a portion where the finger of the user is hooked on the finger hook portion may be configured as an end portion member connected to an end face of the second side end portion in a manner than the end portion member protrudes further in the thickness direction than the spine portion.

According to the folding knife of the fifth form, the portion where the user hooks his/her finger can be easily formed by connecting the end portion member to the side end face of the blade.
[Form 6] In the folding knife described in any of the first, second, and third forms, a portion where the finger of the user is hooked on the finger hook portion may be provided on the blade in a manner allowing the portion to swing in a length direction of the blade in a state where elastic force is generated at an end face of the base end portion closer to the first side end portion and, in the closed state, the portion extends and protrudes out laterally from the grip portion through the through portion, allowing the user to hook his/her finger.

According to the folding knife of the sixth form, even when providing the portion on which the user hooks his/her finger closer to the first side end portion of the blade, the folding knife can have a configuration where the user can easily find the position at which to hook his/her finger in the closed state.
[Form 7] In the folding knife described in any of the first, second, and third forms, the finger hook portion may include a frame portion demarcating a space in which the user can insert his/her finger on a side of the second side end portion of the blade, and at least a portion of the frame portion may constitute a portion where the finger of the user is hooked.

According to the folding knife of the seventh form, the frame portion enables a configuration where the user can more easily and reliably hook his/her finger on the finger hook portion. The frame portion can also function as a hook for pulling the folding knife.

The technology of the present disclosure can be realized in forms other than a folding knife, such as a method of opening and closing a folding knife, a structure of a folding knife, a blade including a finger hook portion, a grip portion including an engagement mechanism and a housing section, or a structure of a finger hook portion.

### BRIEF DESCRIPTION OF DRAWINGS

FIG. 1 is a schematic plan view of a folding knife according to a first embodiment.

FIG. 2 is a schematic side view of a folding knife according to the first embodiment.

FIG. 3 is a schematic side view of a portion where a locking mechanism is provided.

FIG. 4 is a schematic plan view showing the trajectory of a blade as the blade transitions from an open state to a closed state.

FIG. 5 is a schematic side view of the folding knife in the closed state.

FIG. 6 is a schematic cross-sectional view of a finger hook portion according to the first embodiment.

FIG. 7 is a schematic cross-sectional view of a configuration of a groove portion of the blade.

FIG. 8 is a schematic plan view of a folding knife according to a second embodiment.

FIG. 9 is a schematic front view of the folding knife according to the second embodiment.

FIG. 10 is a schematic plan view of a folding knife according to a third embodiment in the open state.

FIG. 11 is a schematic plan view of the folding knife according to the third embodiment in the closed state.

FIG. 12 is a schematic cross-sectional view of the folding knife according to the third embodiment.

FIG. 13 is a schematic plan view of a folding knife according to a fourth embodiment.

FIG. 14 is a schematic view showing a finger hook portion according to the fourth embodiment pulled out.

FIG. 15 is a schematic plan view for describing an operation of the folding knife according to the fourth embodiment.

FIG. 16 is a schematic plan view of another configuration example of the finger hook portion according to the fourth embodiment.

### DESCRIPTION OF EMBODIMENTS

### 1. First Embodiment

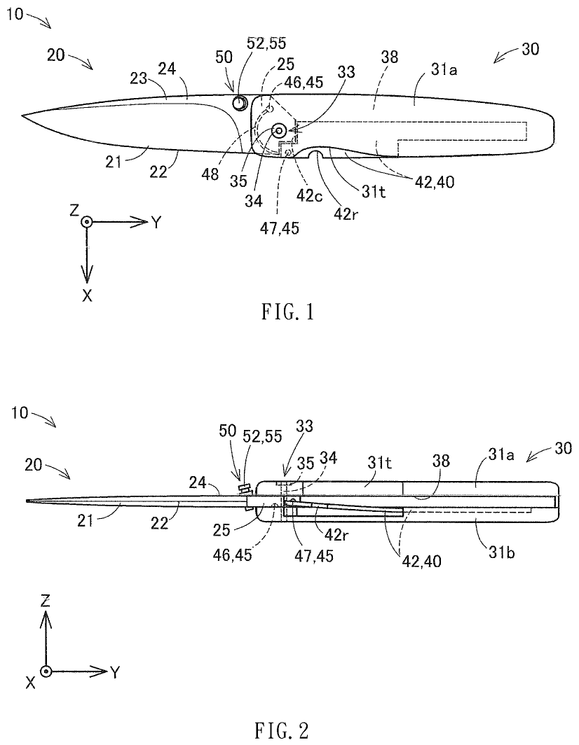

FIG. 1 is a schematic plan view of a folding knife 10 according to a first embodiment. FIG. 2 is a schematic side view of the folding knife 10 according to the first embodiment. FIGS. 1 and 2 show the folding knife 10 in an open state.

FIGS. 1 and 2 include arrows indicating three mutually orthogonal directions: an X direction, a Y direction, and a Z direction. The X direction, the Y direction, and the Z direction correspond to directions of the folding knife 10. The X direction corresponds to the width direction, which is the shorter direction of the folding knife 10. The Y direction corresponds to the length direction, which is the longer direction of the folding knife 10. The Z direction corresponds to the thickness direction of the folding knife 10. The arrows indicating the X direction, the Y direction, and the Z direction are also used in other reference figures.

The folding knife 10 includes a blade 20 with a blade portion 22, and a grip portion 30 to be gripped by a user. The folding knife 10 can be operated from the open state shown in FIGS. 1 and 2 in which the blade 20 and the grip portion 30 are aligned in a row in the length direction to a closed state in which the blade 20 is folded against the grip portion 30 and the blade portion 22 is housed inside the grip portion 30. The closed state of the folding knife 10 and an open/close operation of the folding knife 10 will be described later.

The blade 20 includes the blade portion 22 at a first side end portion 21, which is one end portion of the blade 20 in the width direction. The blade portion 22 is formed from a tip end of the blade 20 in the length direction to just before a base end portion 25 of the blade 20. The blade 20 further includes a spine portion 24 at a second side end portion 23 located on the side opposite to the first side end portion 21 in the width direction. The spine portion 24 is thicker than the blade portion 22.

The blade 20 includes a finger hook portion 50 configured to be operated by the user hooking his/her finger to release the closed state of the folding knife 10 and put the folding knife 10 in the open state. The finger hook portion 50 is provided on the blade 20 at a position closer to the base end portion 25. In the first embodiment, the finger hook portion 50 is provided on the spine portion 24. Details of the configuration of the finger hook portion 50 will be described later.

Referring to FIG. 2, the grip portion 30 includes a pair of outer scale portions 31a and 31b, which are stacked in the thickness direction. The first outer scale portion 31a and the second outer scale portion 31b are each configured by an elongated plate-like member. The base portion 25 of the blade 20 is sandwiched between tip ends of the first outer scale portion 31a and the second outer scale portion 31b.

Referring to FIGS. 1 and 2, a tip end portion of the grip portion 30 sandwiching the base end portion 25 of the blade 20 includes a connecting section 33 that connects the base end portion 25 of the blade 20 to the grip portion 30 in a rotatable manner. The connecting section 33 passes through the first scale portion 31a, the second scale portion 31b, and the base end portion 25 of the blade 20. The connecting section 33 includes a shaft member 34 that serves as a fulcrum for the rotation of the blade 20, and a fastening member 35 that is screwed to an end portion of the shaft member 34. The first scale portion 31a and the second scale portion 31b are fastened to the blade 20 by means of the shaft member 34 and the fastening member 35.

Referring to FIG. 2, the grip portion 30 includes a housing section 38 at a rear end side in the length direction relative to the connecting section 33. The housing section 38 is open sideways at a side face portion of the grip portion 30. When the blade 20 is rotated and folded against the grip portion 30, the blade portion 22 of the blade 20 is received and housed in the housing section 38. The housing section 38 is configured by a slit-like gap between the first scale portion 31a and the second scale portion 31b.

The grip portion 30 includes a locking mechanism 40. The locking mechanism 40 is a portion configured for the user to operate to switch the blade 20 between a “fixed state” and a “rotation-allowed state.” In the fixed state, the blade 20 is fixed at the open position shown in FIGS. 1 and 2. In the rotation-allowed state, the blade 20 is allowed to rotate from the open position.

In the first embodiment, the locking mechanism 40 is configured by a plate spring member 42 disposed in the housing section 38. The plate spring member 42 is disposed such that the length direction, width direction, and thickness direction of the plate spring member 42 coincide with the length direction, width direction, and thickness direction of the grip portion 30, respectively.

A rear end portion of the plate spring member 42 is fixed to the second scale portion 31b. As shown in FIG. 2, in the fixed state, a tip end portion of the plate spring member 42 is positioned away from the second scale portion 31b in the thickness direction. In this state, the tip end portion of the plate spring member 42 comes into contact with a rear end face of the base end portion 25 of the blade 20, which is in the open position, thereby restricting rotation of the blade 20.

As shown in FIG. 1, the tip end portion of the plate spring member 42 preferably includes a notch 42c where a corner portion of the base end portion 25 of the blade 20 engages. With this configuration, when the notch 42c of the plate spring member 42 and the corner portion of the base end portion 25 of the blade 20 engage, fixation between the blade 20 and the grip portion 30 in the fixed state can be improved.

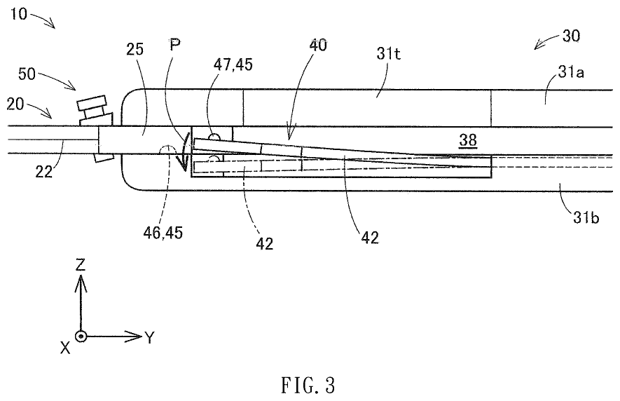

The operation of switching the locking mechanism 40 from the fixed state to the rotation-allowed state will now be described with reference to FIG. 3. FIG. 3 is a schematic side view of a portion where the locking mechanism 40 is provided in the grip portion 30. When the user pushes down the tip end portion of the plate spring member 42 toward the second scale portion 31b with his/her finger, as indicated by the arrow P, the plate spring member 42 is elastically deformed in the thickness direction, and the engagement between the tip end portion of the plate spring member 42 and the base end portion 25 of the blade 20 is released. This allows the blade 20 to rotate with respect to the grip portion 30.

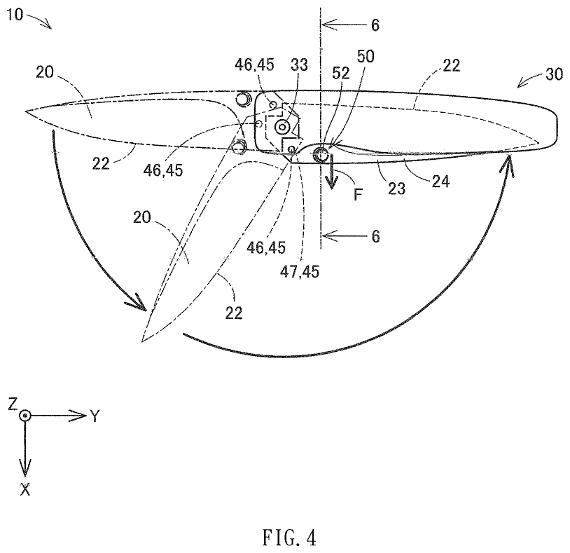

As shown in FIG. 1, the first scale portion 31a of the grip portion 30 according to this embodiment includes a bracket portion 31t having a locally small width. The bracket portion 31t partially exposes the tip end portion of the plate spring member 42 to the outside of the grip portion 30. With this configuration, the user can operate the tip end portion of the plate spring member 42 more easily. Further, providing the bracket portion 31t reduces interference between an operation portion 52 of the finger hook portion 50 and the grip portion 30 when the folding knife 10 is operated to the closed state, as shown in FIG. 4 to be described later.

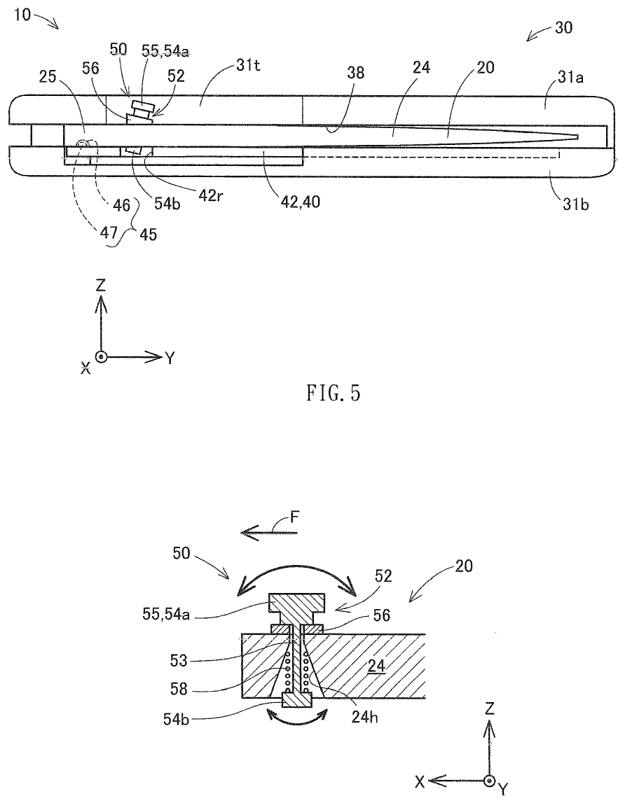

As shown in FIG. 1, a depression 42r is formed in a side face of the tip end portion of the plate spring member 42 according to this embodiment. The depression 42r is locally depressed in the width direction. Forming the depression 42r reduces interference between a second end portion 54b of the finger hook portion 50 and the plate spring member 42 when the folding knife 10 is operated to the closed state, as shown in FIGS. 5 and 6 to be described later.

The mechanism of transitioning the folding knife 10 from the open state to the closed state will now be described with reference to FIGS. 4 and 5. FIG. 4 is a schematic plan view showing the trajectory of the blade 20 as the folding knife 10 transitions from the open state shown in FIG. 1 to the closed state. FIG. 5 is a schematic side view of the folding knife 10 in the closed state.

As explained with reference to FIG. 3, by switching the locking mechanism 40 from the fixed state to the rotation-allowed state, the blade 20 can be rotated relative to the grip portion 30. In the rotation-allowed state, as shown in FIG. 4, the blade 20 is rotated approximately 180° relative to the grip portion 30 from the open position to thereby house the blade portion 22 of the blade 20 in the housing section 38 and place the folding knife 10 in the closed state shown in FIGS. 4 and 5.

When the folding knife 10 is in the closed state, the blade 20 and the grip portion 30 are partially engaged with each other to form an engagement mechanism 45 that restricts rotation of the blade 20. As will be explained below, the engagement mechanism 45 is designed to maintain the engaged state and hold the closed state until an external force of a predetermined magnitude is applied in the direction separating from the housing section 38, that is, in the direction of rotation when opening the folding knife 10 in the closed state.

Referring to FIGS. 1, 2, and 3, in the present embodiment, the engagement mechanism 45 is configured by a concave portion 46 formed in the base end portion 25 of the blade 20 and a convex portion 47 formed at the tip end portion of the plate spring member 42 that constitutes the locking mechanism 40. The concave portion 46 and the convex portion 47 have corresponding shapes that can mate with each other.

In the present embodiment, the convex portion 47 is hemispherical. The hemispherical convex portion 47 can be manufactured by, for example, fitting and fixing a ball-like member in a pre-provisioned hole in the tip end portion of the plate spring member 42.

When the locking mechanism 40 is in the rotation-allowed state as shown in FIG. 3 and the blade 20 is rotated in the direction of the blade portion 22 moving toward the housing section 38 as shown in FIG. 4, the base end portion 25 of the blade 20 rotates while scraping against the vertex of the convex portion 47 of the plate spring member 42. If the convex portion 47 has a hemispherical shape as described above, the frictional force of the convex portion 47 prevents the blade 20 from being inhibited in its rotation at this time. Note that, in the folding knife 10 according to the present embodiment, a groove portion 48 is formed in the base end portion 25 of the blade 20. The convex portion 47 passes through the groove portion 48 when the blade 20 rotates. The configuration and function of the groove portion 48 will be described below.

Referring to FIGS. 4 and 5, as shown in FIG. 4, as the base end portion 25 of the blade 20 is rotated, the concave portion 46 provided in the base end portion 25 moves around the connection portion 33 and reaches a position where it overlaps the convex portion 47 when the blade 20 has reached the closed position. The convex portion 47 fits into the concave portion 46 and engages with the concave portion 46 as shown in FIG. 5 due to a snap fit action caused by the elastic force of the plate spring member 42. This engagement between the concave portion 46 and the convex portion 47 restricts the blade 20 from rotating on its own without an operation by the user when the folding knife 10 is in the closed state.

As described above, the engagement mechanism 45 is configured to remain in the engaged state until a predetermined external force in the direction separating from the housing section 38 is applied to the blade 20. The predetermined external force that releases the engaged state of the engagement mechanism 45 is hereinafter also referred to as “disengaging external force.” The magnitude of the disengaging external force can be adjusted, for example, by the modulus of elasticity of the plate spring member 42, the size and shape of the concave portion 46 and the convex portion 47, and the angle of a wall face of a locking wall portion 48w to be described below.

Now, the configuration of the finger hook portion 50 and the operation of transitioning the folding knife 10 from the closed state to the open state will be described with reference to FIGS. 4, 5, and 6 as appropriate. FIG. 6 is a schematic side view of the finger hook portion 50, showing a cross section along the line 6-6 in FIG. 4.

Referring to FIG. 6, as described above, the finger hook portion 50 is a component designed for the user to hook a finger on to apply an external force to rotate the blade, to thereby release the closed state of the folding knife 10. The finger hook portion 50 is configured to, when the user applies the external force by hooking his/her finger to open the folding knife 10 in the closed state, generate an elastic force that repels the external force. The finger hook portion 50 according to the first embodiment includes the operation portion 52 configured by an axial member, and an elastic member 58 configured to bias the operation portion 52.

The operation portion 52 is inserted into a through hole 24h configured to extend through the spine portion 24 of the blade 20 in the thickness direction, thereby being supported by the blade 20. The through hole 24h has a tapered configuration in which the inner diameter gradually expands from one open end portion to the other open end portion.

The operation portion 52 includes a main shaft portion 53 disposed within the through hole 24h. The main shaft portion 53 has a diameter smaller than the smaller open end portion of the through hole 24h. With this configuration, a clearance is formed between the main shaft portion 53 and an inner wall face of the through hole 24h. The operation portion 52 includes first and second end portions 54a and 54b located on either side of the main shaft portion 53. The two end portions 54a and 54b each have a larger diameter than the main shaft portion 53. At least one of the two end portions 54a and 54b is connected to the main shaft portion 53 via a screw, for example.

The first end portion 54a of the operation portion 52 has a diameter larger than the smaller open end portion of the through hole 24h and is disposed outside the through hole 24h. The first end portion 54a constitutes a projecting portion 55 projecting from a surface of the spine portion 24 in the thickness direction of the blade 20. The projecting portion 55 corresponds to a portion on which the user hooks his/her finger in the finger hook portion 50 according to the first embodiment.

The second end portion 54b of the operation portion 52 has a diameter larger than the smaller open end portion of the through hole 24h, and has a diameter smaller than the larger open end portion of the through hole 24h. The second end portion 54b prevents the operation portion 52 from falling from the through hole 24h.

The elastic member 58 according to the first embodiment is configured by a coil spring and is disposed around the main shaft portion 53. The diameter of the coil spring configuring the elastic member 58 is smaller than the diameter of the second end portion 54b. The elastic member 58 is held around the main shaft portion 53 by the second end portion 54b. The elastic member 58 is installed in a biased state with one end portion in contact with the inner wall of the through hole 24h and the other end portion in contact with the second end portion 54b. The elastic force of the elastic member 58 stabilizes the installation posture of the operation portion 52.

Referring to FIG. 5, the finger hook portion 50 according to the first embodiment further includes a base portion 56 for tilting the installation posture of the operation portion 52. The base portion 56 is configured by an annular member having a central hole through which the main shaft portion 53 of the operation portion 52 is inserted, and is disposed under the projecting portion 55.

The face of the base portion 56 facing a bottom face of the projecting portion 55 is inclined with respect to the surface of the spine portion 24 of the blade 20. The inclination of the face of the base portion 56 causes a central axis of the operation portion 52 to be inclined with respect to the thickness direction when the finger of the user is not hooked on the projecting portion 55. The projecting portion 55 is inclined by the base portion 56 to fall toward the tip end of the blade 20. When the folding knife 10 is in the closed state, the projecting portion 55 is inclined to fall toward the rear end of the grip portion 30. When the projecting portion 55 is inclined in this way, the user can more easily put his/her finger on the projecting portion 55 when opening the folding knife 10. Note that the base portion 56 is not an essential component of the first embodiment and may be omitted.

In the finger hook portion 50 according to the first embodiment, as described above, since the main shaft portion 53 and the two end portions 54a and 54b of the operation portion 52 are installed such that a clearance is formed between them and the inner wall face of the through hole 24h, the operation portion 52 is supported by the blade 20 in a state where the posture of the operation portion 52 is allowed to fluctuate within a predetermined range. When the posture of the operation portion 52 has fluctuated, the elastic member 58 elastically deforms to generate an elastic force in a direction that repels the fluctuation. This elastic force acts in the direction of assisting rotation of the blade 20 when the user puts the folding knife 10, which is in the closed state, in the open state. Thus, the operation of releasing the closed state of the folding knife 10 is facilitated by the elastic force.

The operation of transitioning the folding knife 10 in the closed state to the open state will now be explained with reference to FIGS. 4, 5, and 6.

To release the closed state of the folding knife 10, the user, for example, places the thumb of his/her hand that is gripping the grip portion 30 on the projecting portion 55 of the finger hook portion 50 to apply an external force to the projecting portion 55 in the direction of rotating the blade 20, as indicated by the arrow F in FIG. 4. This causes the posture of the projecting portion 55 to fluctuate so that the projecting portion 55 tilts in the direction indicated by the arrow F in FIG. 6, and the elastic member 58 generates an elastic force in a direction that repels the posture fluctuation, that is, in a direction that rotates the blade 20.

In the first embodiment, the elastic force generated by the finger hook portion 50 at this time is smaller than the magnitude of the disengaging external force, which is a condition for releasing the engagement state of the engagement mechanism 45 described above. Thus, the engagement state of the engagement mechanism 45 is maintained until a combined force of the force applied to the finger hook portion 50 by the finger of the user and the elastic force generated by the elastic deformation of the elastic member 58 of the finger hook portion 50 exceeds the magnitude of the disengaging external force. Further, the engagement state of the engagement mechanism 45 is released the moment the combined force exceeds the magnitude of the disengaging external force.

When the engagement state of the engagement mechanism 45 is released, the elastic force generated by the finger hook portion 50 is instantaneously released, thereby acting as an instantaneous force to rotate the blade 20. This instantaneous force assists in rotating the blade 20 to the open position, so the user can easily open the folding knife 10 with less force. This instantaneous force also speeds up the rotation of the blade 20. This improves the user's feeling of operation when opening the folding knife 10.

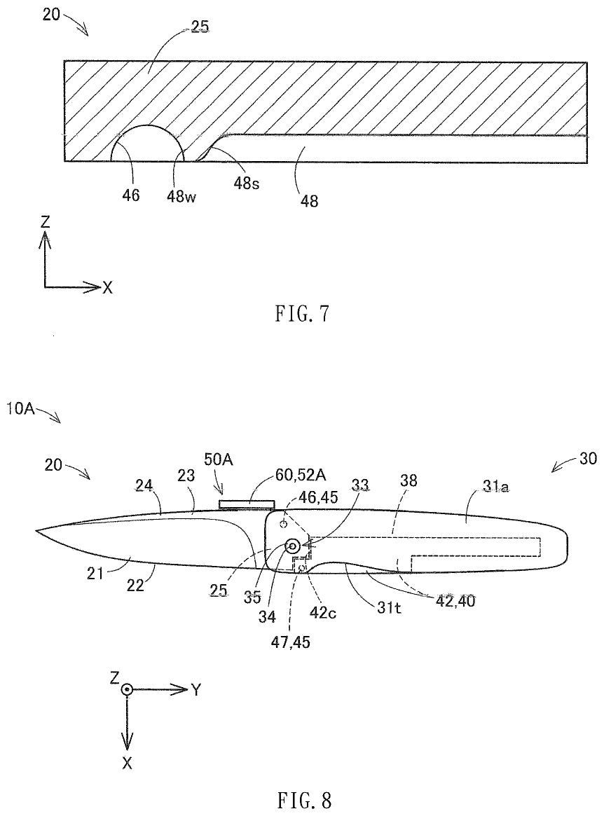

The groove portion 48 provided to speed up the rotation of the blade 20 when opening the folding knife 10 will now be explained with reference to FIGS. 1 and 7. As described above, the groove portion 48 is formed in the base end portion 25 of the blade 20 in the folding knife 10 according to the present embodiment. In FIG. 1, the groove portion 48 is indicated by a dashed line. The groove portion 48 is formed on a path on which the convex portion 47 of the engagement mechanism 45 passes over the base end portion 25 when the blade 20 is rotated relative to the grip portion 30.

FIG. 7 is a schematic cross-sectional view of the base end portion 25 along the groove portion 48. The groove portion 48 includes the locking wall portion 48w in front of the concave portion 46. A wall face of the locking wall portion 48w on the groove portion 48 side has a gently sloping slope 48s. The angle of inclination of the slope 48s becomes more gradual the higher up the groove portion 48. A wall face of the locking wall portion 48w on a side opposite to the slope 48s constitutes a portion of the inner wall face of the concave portion 46. When the folding knife 10 is closed, the convex portion 45 engages by traveling over the locking wall portion 48w and fitting into the concave portion 46. When the folding knife 10 is opened, the engagement state of the engagement mechanism 45 is released by the convex portion 45 traveling over the locking wall portion 48w and separating from the concave portion 46. After the engagement state is released, the concave portion 45 moves along the groove portion 48.

By providing the groove portion 48, resistance caused by the friction of the convex portion 45 when the blade 20 is rotated relative to the grip portion 30 can be reduced compared to a case where the groove portion 48 is not provided. Thus, it is possible to speed up rotation of the blade 20 when opening the folding knife 10. Note that, the groove portion 48 is not an essential component of the folding knife 10 according to this embodiment and may be omitted.

As described above, with the folding knife 10 according to the first embodiment, the user can release the closed state of the folding knife 10 by rotating the blade 20 with a simple operation of placing his/her finger on the finger hook portion 50. Since the elastic force generated by the finger hook portion 50 at this time acts in the direction of assisting the rotation of the blade 20, the operation of opening the folding knife 10 is further facilitated. In addition, with the folding knife 10 according to the first embodiment, since the rotation of the blade 20 is restricted by the engagement mechanism 45 when the blade 20 is in the folded closed state, the blade 20 is restricted from rotating unexpectedly and releasing the closed state.

In addition, with the folding knife 10 according to the first embodiment, since the finger hook portion 50 has a simple configuration, the number of parts required to provide the finger hook portion 50 can be reduced. With the folding knife 10 according to the first embodiment, since the open/close operation performed by the user is basically the same as that of a conventional folding knife, the user can easily get used to the operation. It is also possible to configure a conventional folding knife so that the effects described above can be obtained without major design changes.

### 2. Second Embodiment

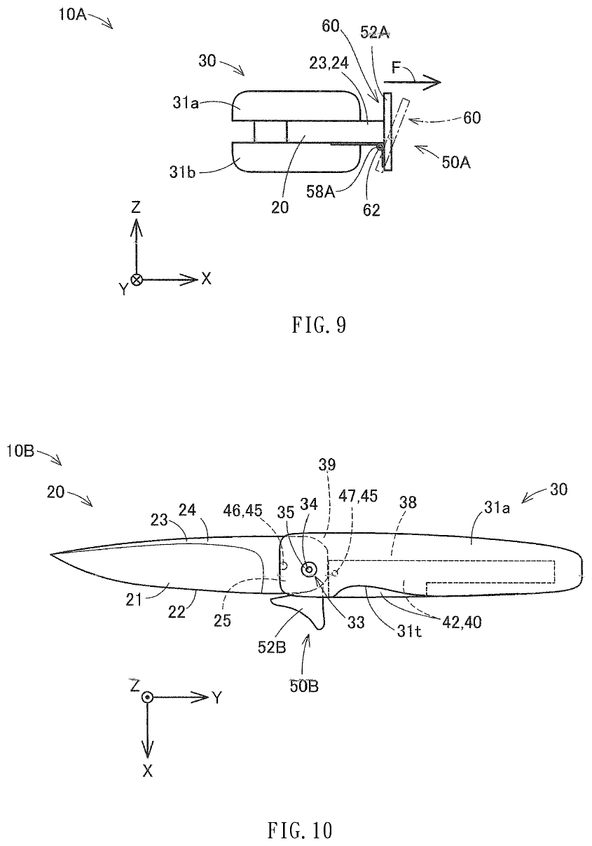

The configuration of a folding knife 10A according to a second embodiment will be described with reference to FIGS. 8 and 9. FIG. 8 is a schematic plan view of the folding knife 10A according to the second embodiment when in the open state. FIG. 9 is a schematic front view of the grip portion 30 of the folding knife 10A according to the second embodiment in the closed state, viewed from the tip end to the rear end.

The configuration of the folding knife 10A according to the second embodiment is basically the same as that of the folding knife 10 according to the first embodiment except that a finger grip portion 50A with a different configuration is provided in place of the finger grip portion 50 according to the first embodiment, and the depression 42r of the plate spring member 42 configuring the locking mechanism 40 is omitted. The finger grip portion 50A according to the second embodiment includes an end portion member 60 attached to an end face of the second side end portion 23 of the blade 20, a joint portion 62 that connects the end portion member 60 and the blade 20, and the elastic member 58 that biases the end portion member 60.

The end portion member 60 is configured by a plate-like member and is attached close to the base end portion 25 of the blade 20. The end portion member 60 is connected to the blade 20 in a posture in which its plate face faces the end face of the second side end portion 23 of the blade 20, and in a state where an end portion of the end portion member 60 protrudes further in the width direction than the spine portion 24 of the blade 20.

The joint portion 62 is configured by, for example, a hinge mechanism. As shown in FIG. 9, the end portion member 60 is connected to the blade 20 by the joint member 62 in a rotatable manner. Both ends of the end portion member 60 in the thickness direction of the folding knife 10A can be alternately displaced in the width direction of the folding knife 10A with the joint portion 62 as the fulcrum. Note that, the direction in which fluctuation of the posture of the end portion member 60 is allowed is not limited to the width direction. For example, the end portion member 60 of the finger hook portion 50A may be connected to the blade 20 in a swingable manner in the front-rear direction of the blade 20.

In the folding knife 10A, the location at which the end portion member 60 protrudes further than the spine portion 24 of the blade 20 is the location where the user hooks his/her finger. This location corresponds to an operation portion 52A supported by the blade 20 in a state where posture fluctuation is allowed within a predetermined range when the user has hooked his/her finger.

The elastic member 58A is configured by, for example, a torsion spring. The elastic member 58A is attached so as to bias an end portion of the end portion member 60 on a side opposite to the operation portion 52A toward the outside in the width direction of the blade 20. With this configuration, when the user hooks his/her finger on the operation portion 52A of the end portion member 60 and applies an external force in the direction of rotating the blade 20 to the open position as indicated by the arrow F in FIG. 9, the elastic member 58A generates an elastic force that repels the external force.

In other embodiments, the elastic member 58A may be configured by a spring member or an elastic member other than a torsion spring. In addition, the end portion member 60 may be connected to the end face of the blade 20 via a connection portion configured by an elastic member in place of the joint member 62 configured of a hinge mechanism, in a state where the posture in which elastic force is generated fluctuates. In other embodiments, the joint member 62 and the elastic member 58A may be omitted, and an end portion member that elastically deforms in the thickness direction may be connected to the end face of the blade 20.

In the folding knife 10A, similar to the folding knife 10 according to the first embodiment, in the closed state, the engagement between the concave portion 46 and the convex portion 47 configuring the engagement mechanism 45 restricts the blade 20 from rotating to the open direction. In the second embodiment, similar to the first embodiment, the elastic force generated by the elastic member 58A when releasing the closed state is smaller than the disengaging external force for releasing the engagement state of the engagement mechanism 45. With this configuration, the engagement state of the engagement mechanism 45 is released the instant the combined force of the force applied to the finger hook portion 50A by the user and the elastic force of the elastic member 58A exceeds the magnitude of the disengaging external force.

With the folding knife 10A, similar to the folding knife 10 according to the first embodiment, in the closed state, the user can, for example, place the thumb of the hand gripping the grip portion 30 on the operation portion 52A and press to rotate the blade 20 to easily put the folding knife 10A in the open state. Further, when putting the folding knife 10A in the open state, similar to the first embodiment described above, the elastic force of the elastic member 58A creates an instantaneous force that assists rotation of the blade 20.

With the folding knife 10A, it is possible to easily form the finger hook portion 50A in a shape that is easy for the user to hook his/her finger on by connecting the end portion member 60 to the side end face of the blade 20. Further, this configuration of the finger hook portion 50A can be easily retrofitted to the blade 20, thus facilitating manufacture of the folding knife 10A. The folding knife 10A can also achieve various other effects similar to those described in the first embodiment.

### 3. Third Embodiment

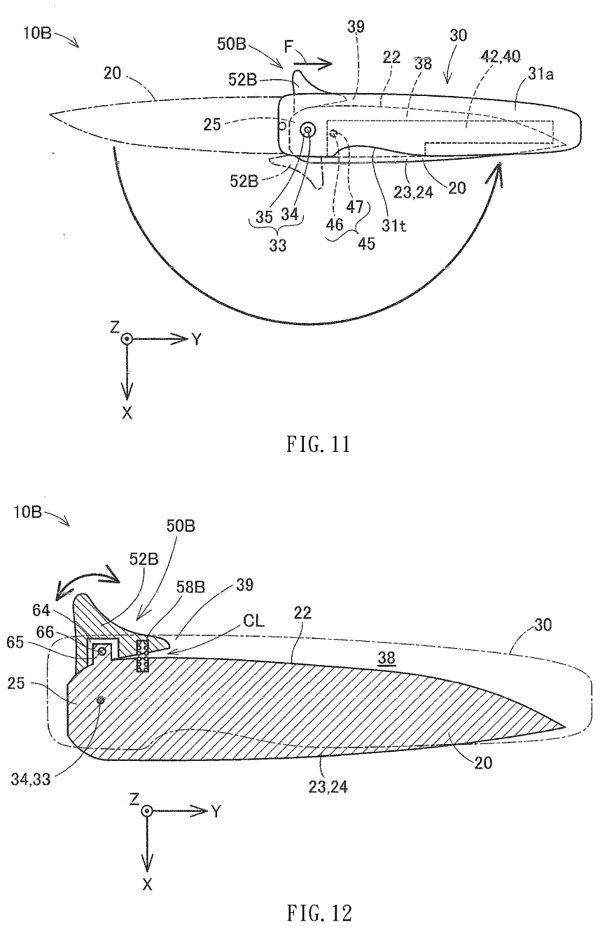

The configuration of a folding knife 10B according to a third embodiment will be described with reference to FIGS. 10, 11, and 12, in that order. FIG. 10 is a schematic plan view of the folding knife 10B according to the third embodiment in the open state. FIG. 11 is a schematic plan view of the folding knife 10B in the closed state. In FIG. 11, for convenience, the positions of the blade 20 and a finger hook portion 50B in the open state are indicated by a single dotted line. FIG. 12 is a schematic cross-sectional view of the folding knife 10B in the closed state, taken along a cross section passing through the center of the folding knife 10B in the thickness direction. In FIG. 12, for convenience, the grip portion 30 is indicated by a single dotted line.

Referring to FIGS. 10 and 11, the configuration of the folding knife 10B according to the third embodiment is basically the same as the configuration of the folding knife 10 according to the first embodiment except for the points described below. In the folding knife 10B, the finger hook portion 50B having a different configuration is provided in place of the finger hook portion 50 according to the first embodiment, and the shapes of the blade 20 and the locking mechanism 40 are partially changed.

The finger hook portion 50B according to the third embodiment is provided on the end face of the first side end portion 21 at the base end portion 25 of the blade 20. The finger hook portion 50B includes an operation portion 52B configured by a plate-like member. As shown in the drawings, the operation portion 52B may, for example, have a near triangular shape. The shape of the operation portion 52B is not limited to that shown in the drawings. The operation portion 52B may be configured by, for example, a shaft-like member protruding from the end face of the base end portion 25. The operation portion 52B is connected with its end face facing the end face of the base end portion 25.

In the third embodiment, the corner portion of the base end portion 25 of the blade 20 described in the first embodiment is omitted to allow for the connection of the operation portion 52B. In addition, the notch portion 42c at the tip end portion of the plate spring member 42 configuring the locking mechanism 40 is omitted and instead a tip end face in surface contact with the rear end face of the base end portion 25 of the blade 20 when in the locked state is formed.

In the third embodiment, the housing section 38 includes a through portion 39 on the tip end side of the grip portion 30. The through portion 39 extends through the grip portion 30 in the width direction. When the blade 20 is rotated from the open state position to the closed state position, the operation portion 52B connected to the base end portion 25 moves within the through hole 39 of the housing section 38 and, as shown in FIG. 11, extends out laterally from the grip portion 30 through the through portion 39.

The location of the operation portion 52B that extends laterally from the grip portion 30 in the closed state corresponds to the location where the user hooks his/her finger. As described below, the operation portion 52B is connected to the base end portion 25 of the blade 20 in a state where posture variation is permitted within a predetermined range when the user's finger is hooked.

Referring to FIG. 12, the operation portion 52B is connected in a state that allows the operation portion 52B to swing in the direction of the length of the blade 20. As described above, the operation portion 52B is connected to the base end portion 25 of the blade 20 in a state where an end face of the operation portion 52B and an end face of the base end portion 25 face each other. The end face of the operation portion 52B and the end face of the base end portion 25 of the blade 20 are not configured to be in surface contact but are configured by faces such that a clearance CL is created on either side of the swing direction across a swing shaft 66 to allow the operation portion 52B to swing.

A connection concave portion 64 is formed inside the operation portion 52B. The connection concave portion 64 is open at the end face facing the base end portion 25 of the blade 20. Further, an insertion convex portion 65 is formed at the end face of the base end portion 25 of the blade 20. The insertion convex portion 65 is to be inserted into the connection concave portion 64.

In a state where the insertion convex portion 65 is inserted into the connection concave portion 64, a space for allowing the operation portion 52B to swing is formed around the insertion convex portion 65. The operation portion 52B is connected to the base end portion 25 of the blade 20 when the swing shaft 66 that functions as a swing fulcrum extends through the operation portion 52B and the insertion convex portion 65 inserted into the connection concave portion 64 in the thickness direction.

The finger hook portion 50B, together with the operation portion 52B, includes an elastic member 58B that generates an elastic force repelling fluctuation when the posture of the operation portion 52B fluctuates after the user hooks his/her finger on the operation portion 52B. The elastic member 58B is configured by, for example, a coil spring. The elastic member 58B is housed in hole portions formed inside the operation portion 52B and the blade 20. The elastic member 58B biases the operation member 52B to tilt from the tip end portion side to the base end portion 25 side of the blade 20 with the swing axis 66 as the fulcrum.

The elastic member 58 of the finger hook portion 50B may not be configured by a coil spring. The elastic member 58B of the finger hook portion 50B may be configured by, for example, a torsion spring. The elastic member 58B may be configured by a spring member other than a coil spring or a torsion spring, or another elastic member.

Referring to FIG. 11, the user may, for example, hook the pointer finger of the hand gripping the grip portion 30 of the folding knife 10B in the closed state on the operation portion 52B and apply external force in the direction of the arrow F to the operation portion 52B to tilt the operation portion 52B toward a rear end portion of the grip portion 30. This causes the elastic member 58B to generate an elastic force against this external force.

In the third embodiment, similar to the first and second embodiments, the elastic force generated by the elastic member 58B when the closed state is released is smaller than the disengaging external force of the engagement mechanism 45. Therefore, when the combined force of the force applied by the user and the elastic force of the elastic member 58B exceeds the magnitude of the disengaging external force, the engagement state of the engagement mechanism 45 is released.

When the engagement state of the engagement mechanism 45 is released, rotation of the blade 20 to the position in the open state is allowed, and the folding knife 10B rotates to the position in the open state. At this time, the instantaneous force generated by the elastic force of the elastic member 58B acts in the direction to assist the rotation of the blade 20, as described in the first and second embodiments.

As described above, with the folding knife 10B according to the third embodiment, the finger hook portion 50B can be provided on the side of the first side end portion 21 of the blade 20. Also, when the folding knife 10B is in the closed state, the operation portion 52B of the finger hook portion 50B can be placed in a position where the user can easily hook his/her finger. The folding knife 10B according to the third embodiment can also achieve various other effects similar to those described in the first and second embodiments.

### 4. Fourth Embodiment

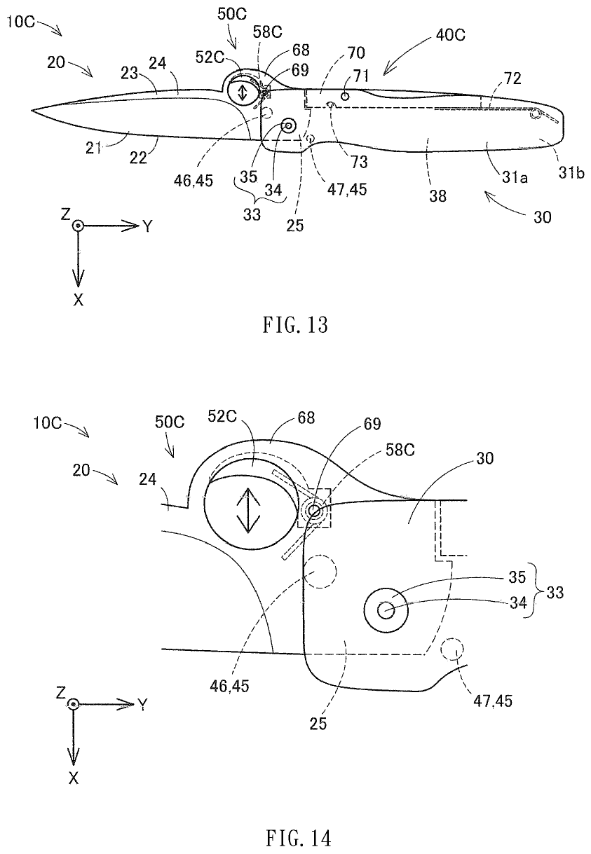

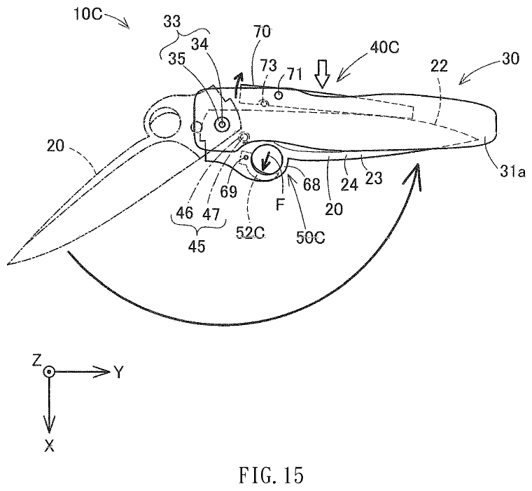

The configuration of a folding knife 10C according to a fourth embodiment will be described with reference to FIGS. 13, 14, and 15. FIG. 13 is a schematic plan view of the folding knife 10C according to the fourth embodiment in the open state. FIG. 14 is a schematic view showing a finger hook portion 50C according to the fourth embodiment shown in FIG. 13 pulled out. FIG. 15 is a schematic plan view for describing operation of the folding knife 10C according to the fourth embodiment from the open state to the closed state.

Referring to FIG. 13, the folding knife 10C according to the fourth embodiment has basically the same configuration as the folding knife 10 according to the first embodiment except that the folding knife 10C includes the finger hook portion 50C having a different configuration and a locking mechanism 40C.

Referring to FIGS. 13 and 14, the finger hook portion 50C according to the fourth embodiment is provided at a position closer to the base end portion 25 on the second side end portion 23 of the blade 20. The finger hook portion 50C includes a frame portion 68 that demarcates a space into which the user can insert a finger.

As shown in FIG. 13, the frame portion 68 is formed by a curved frame with a circular hole portion into which a finger is inserted, for example. The space to insert a finger may not be completely enclosed by the frame portion 68 or may be partially broken by the frame portion 68. The shape of the frame portion 68 is not limited to any particular shape and may be a combination of straight bar-shaped sections. The frame portion 68 can also function as a hook for hooking and fastening the folding knife 10C.

The frame portion 68 of the finger hook portion 50C is provided with an operation portion 52C on the inner side facing the space into which the user inserts his/her finger. Although not shown in the drawings, the frame portion 68 is provided with slits for placing the operation portion 52C in the thickness direction. The operation portion 52C is configured in the form of a trigger, for example, as illustrated in the drawings.

A portion of the operation portion 52C is exposed to the space into which the user inserts his/her finger, and the portion is housed inside the frame portion 68. The operation portion 52C is connected to the blade 20 in a rotatable manner about a through shaft 69 that extends through an end portion of the operation portion 52C in the thickness direction. When the finger of the user is hooked on the portion disposed outside the frame portion 58, the operation portion 52C is configured to rotate toward the back of the slit in the frame portion 68 using the through shaft 69 as the fulcrum.

The finger hook portion 50C includes an elastic member 58C that generates an elastic force repelling rotation when the finger of the user is hooked on the operation portion 52C. The elastic member 58C is configured by, for example, a torsion spring. The elastic member 58C is disposed inside the frame portion 68 and is wound around the through shaft 69. The elastic member 58C may be configured by a spring member other than a torsion spring or by another elastic member.

Referring to FIG. 13, the locking mechanism 40C according to the fourth embodiment is configured by an elongated plate-like lever member 70 that is sandwiched between the first scale portion 31a and the second scale portion 31b, which constitute the grip portion 3. The lever member 70 is disposed such that the length direction, width direction, and thickness direction of the lever member 70 coincide with the length direction, width direction, and thickness direction of the grip portion 30, respectively. The lever member 70 is disposed at a position close to the side end portion of the grip portion 30. A side end portion of the lever member 70 is partially exposed from the grip portion 30.

The lever member 70 is rotatably attached to the grip portion 30 by means of a fixed shaft 71 as a fulcrum. The fixed shaft 71 is fixed to the first scale portion 31a and the second scale portion 31b at both ends and extends through the lever member 70 in the thickness direction.

A portion of the lever member 70 closer to the rear end side than the fixed shaft 71 is biased outward in the width direction by a biasing member 72 disposed inside the grip portion 30. A portion of the lever member 70 closer to the tip end than the fixed shaft 71 is locked by a locking shaft 73 provided inside the grip portion 30 when the portion closer to the rear end side is biased by the biasing member 72.

A corner portion is provided at a tip end portion of the lever member 70. In the locked state, the corner portion of the lever member 70 is fitted into and engages with a corner portion provided in the base end portion 25 of the blade 20 to restrict rotation of the blade 20 from the open state position.

Referring to FIG. 15, the user can push a portion of the lever member 70 exposed from the side end portion of the grip portion 30 with a force that exceeds the biasing force of the biasing member 72 to rotate the lever member 70 about the fixed shaft 71. This rotation causes the engagement between the corner portion of the lever member 70 and the corner portion of the blade 20 to release and achieves the rotation allowed state in which rotation of the blade 20 is allowed.

When the locking mechanism 40C is in the rotation allowed state, the blade 20 can be rotated from the open position to place the folding knife 10C in the closed state. When the folding knife 10C has entered the closed state, the lever member 70 is returned to the same position as in the locked state by the biasing force of the biasing member 72.

The folding knife 10C includes the engagement mechanism 45, similar to that described in the first embodiment. In the closed state of the folding knife 10C, the engagement between the concave portion 46 and the convex portion 47, which constitute the engagement mechanism 45, restricts the blade 20 from rotating until the disengaging external force is applied to the blade 20.

To open the closed folding knife 10C, the user inserts the thumb of the hand gripping the grip portion 30 into the space demarcated by the frame portion 68 and places the back of the thumb against the operation portion 52C to apply an external force to the operation portion 52C in the direction of the arrow F. This causes the operation portion 52C to rotate with the through shaft 69 as a fulcrum and the elastic member 58C to elastically deform to generate an elastic force.

In the fourth embodiment, as in the first, second and third embodiments, the elastic force generated by the elastic member 58C when the closed state is released is smaller than the disengaging external force of the engagement mechanism 45. Thus, the engagement state of the engagement mechanism 45 is disengaged when the combined force of the force applied by the finger of the user and the elastic force of the elastic member 58C exceeds the magnitude of the disengaging external force of the engagement member 45.

When the engagement state of the engagement mechanism 45 is released, the blade 20 begins to rotate to the open state position. At this time, the instantaneous force generated by the elastic force of the elastic member 58C acts in the direction assisting rotation of the blade 20, similar to that described in the first, second, and third embodiments.

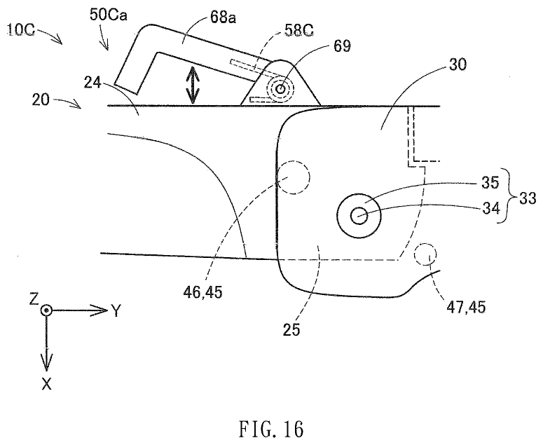

FIG. 16 is a schematic diagram of a finger hook portion 50Ca, which is another configuration example of the finger hook portion 50C according to the fourth embodiment. In the finger hook portion 50Ca of this configuration example, the lever member 70 is omitted. A frame portion 68a of the finger hook portion 50Ca also functions as an operation member and is configured to rotate about the through shaft 69 provided at the connection portion with the blade 20 in a state where elastic force is generated by the elastic member 58C. Even with such a configuration, the same effects as that of the finger hook portion 50C can be achieved.

As described above, the folding knife 10C according to the fourth embodiment makes it easier for the user to hook his/her finger on the finger hook portion 50C more reliably because the finger hook portion 50C includes the frame portion 68. The folding knife 10C according to the fourth embodiment can also achieve various other effects similar to those described in the first, second, and third embodiments.

### 5. Other Embodiments

The technology of the present disclosure is not limited to the configurations of the above-described embodiments and can be modified as follows. The other embodiments described below are all positioned as examples of forms for implementing the technology of the present disclosure in the same manner as the above embodiments.

### (1) Other Embodiment 1

The finger hook portion may be configured to generate an elastic force when the user hooks a finger on the finger hook portion by a different configuration from that described in the above embodiments. The finger hook portion may be configured to generate an elastic force by elastic deformation when the user hooks his/her finger on the finger hook portion, for example, by having the portion on which the user hooks his/her finger configured by an elastic member such as rubber.

### (2) Other Embodiment 2

The finger hook portion may be configured to generate, as an elastic force, an attraction or repulsion force due to a magnetic force when the user hooks his/her finger on the finger hook portion, instead of being configured to generate an elastic force by elastic deformation of an elastic member when the user hooks his/her finger on the finger hook portion.

### (3) Other Embodiment 3

In each of the above-described embodiments, when the closed state is released, the elastic force generated by the user placing his/her finger on the finger hook portion 50, 50A, 50B, 50C, 50Ca may be greater than the disengaging external force that disengages the engagement state of the engagement mechanism 45. Even with such a configuration, the elastic force generated by the finger hook portion 50, 50A, 50B, 50C, 50Ca acts in the direction of assisting the rotation of the blade 20, thereby facilitating the operation of opening the folding knife 10, 10A, 10B, 10C in the closed state.

### (4) Other Embodiment 4

The locking mechanism 40, 40C and the engagement mechanism 45 of the folding knife 10, 10A, 10B, 10C according to the above-described embodiments are not limited to the configurations described in the above embodiments. For example, the locking mechanism 40C according to the third embodiment may be applied to the folding knife 10, 10A, 10B, 10C according to other embodiments, or the locking mechanism 40 according to other embodiments may be applied to the folding knife 10C according to the third embodiment. In the folding knife 10, 10A, 10B, 10C of the embodiments described above, the engagement mechanism 45 may be altered to have a configuration in which the convex portion 46 and the concave portion 47 are switched, or altered to have a configuration in which steps provided in each of the blade and the grip portion engage with each other, for example.

### (5) Other Embodiment 5

The configurations of the finger hook portions described in each of the above embodiments and in the other embodiments above may be applied to other instruments with folding mechanisms other than folding knives. For example, the configurations may be applied to eating utensils such as spoons and forks, writing utensils such as pens and rulers, and cosmetics utensils such as combs, etc., which have a folding mechanism.

1. A folding knife comprising:
a blade including a blade portion on a first side end portion and a spine portion on a second side end portion;
a grip portion to be gripped by a user;
a connection portion connecting a base end portion of the blade to the grip portion in a rotatable manner;
a housing section open at a side face portion of the grip portion and being configured to receive the blade portion when the blade is rotated and folded with respect to the grip portion; and
a finger hook portion provided in the blade and disposed outside the housing section in a closed state, the finger hook portion being configured to, when the user applies an external force by hooking his/her finger on the finger hook portion to rotate the blade and release the closed state, generate an elastic force in a direction repelling the external force.

2. The folding knife according to claim 1, further comprising:
an engagement mechanism configured to hold the closed state until an external force having a predetermined magnitude in a direction separating from the housing section is applied to the blade, the closed state being a state where the blade portion is housed in the housing section and rotation of the blade against the grip portion is restricted by a portion of the blade and a portion of the housing section being engaged, wherein
the elastic force generated by the finger hook portion when the user hooks his/her finger on the finger hook portion to release the closed state is smaller than the predetermined external force for releasing engagement of the engagement mechanism.

3. The folding knife according to claim 2, wherein the finger hook portion includes
an operation portion supported by the blade in a state where fluctuation of posture of the operation portion within a predetermined range is allowed when the finger of the user is hooked, and
an elastic member configured to generate an elastic force in a direction repelling the fluctuation when the posture of the operation portion fluctuates.

4. The folding knife according to claim 1, wherein a portion where the finger of the user is hooked on the finger hook portion is configured as a projecting portion projecting from a surface of the spine portion in a thickness direction.

5. The folding knife according to claim 2, wherein a portion where the finger of the user is hooked on the finger hook portion is configured as a projecting portion projecting from a surface of the spine portion in a thickness direction.

6. The folding knife according to claim 3, wherein a portion where the finger of the user is hooked on the finger hook portion is configured as a projecting portion projecting from a surface of the spine portion in a thickness direction.

7. The folding knife according to claim 1, wherein a portion where the finger of the user is hooked on the finger hook portion is configured as an end portion member connected to an end face of the second side end portion in a manner than the end portion member protrudes further in the thickness direction than the spine portion.

8. The folding knife according to claim 2, wherein a portion where the finger of the user is hooked on the finger hook portion is configured as an end portion member connected to an end face of the second side end portion in a manner than the end portion member protrudes further in the thickness direction than the spine portion.

9. The folding knife according to claim 3, wherein a portion where the finger of the user is hooked on the finger hook portion is configured as an end portion member connected to an end face of the second side end portion in a manner than the end portion member protrudes further in the thickness direction than the spine portion.

10. The folding knife according to claim 1, wherein
the housing section includes a through portion extending through the grip portion in a width direction, and
a portion where the finger of the user is hooked on the finger hook portion is provided on the blade in a manner allowing the portion to swing in a length direction of the blade in a state where elastic force is generated at an end face of the base end portion closer to the first side end portion and, in the closed state, the portion extends and protrudes out laterally from the grip portion through the through portion, allowing the user to hook his/her finger.

11. The folding knife according to claim 2, wherein
the housing section includes a through portion extending through the grip portion in a width direction, and
a portion where the finger of the user is hooked on the finger hook portion is provided on the blade in a manner allowing the portion to swing in a length direction of the blade in a state where elastic force is generated at an end face of the base end portion closer to the first side end portion and, in the closed state, the portion extends and protrudes out laterally from the grip portion through the through portion, allowing the user to hook his/her finger.

12. The folding knife according to claim 3, wherein
the housing section includes a through portion extending through the grip portion in a width direction, and
a portion where the finger of the user is hooked on the finger hook portion is provided on the blade in a manner allowing the portion to swing in a length direction of the blade in a state where elastic force is generated at an end face of the base end portion closer to the first side end portion and, in the closed state, the portion extends and protrudes out laterally from the grip portion through the through portion, allowing the user to hook his/her finger.

13. The folding knife according to claim 1, wherein
the finger hook portion includes a frame portion demarcating a space in which the user can insert his/her finger on a side of the second side end portion of the blade, and
at least a portion of the frame portion constitutes a portion where the finger of the user is hooked.

14. The folding knife according to claim 2, wherein
the finger hook portion includes a frame portion demarcating a space in which the user can insert his/her finger on a side of the second side end portion of the blade, and
at least a portion of the frame portion constitutes a portion where the finger of the user is hooked.

15. The folding knife according to claim 3, wherein
the finger hook portion includes a frame portion demarcating a space in which the user can insert his/her finger on a side of the second side end portion of the blade, and
at least a portion of the frame portion constitutes a portion where the finger of the user is hooked.
